(19) United States
(12) Patent Application Publication
(10) Pub. No.: US 2026/0030233 A1
(43) Pub. Date: Jan. 29, 2026

(54) ROWLOCKING FOR DIVERSE STORES

(71) Applicant: SAP SE, Walldorf (DE)

(72) Inventors: Manuel Mayr, Walldorf (DE); Wolfgang Stephan, Heidelberg (DE)

(21) Appl. No.: 18/787,200

(22) Filed: Jul. 29, 2024

(51) Int. Cl. G06F 16/23; G06F 16/2453

(52) U.S. Cl. CPC G06F 16/2343; G06F 16/24542

(57) ABSTRACT

A database system receives a query targeting a plurality of different database table types, where the query includes a rowlock request. The database system creates a plurality of rowlock accessors for a plurality of storage layers in response to receiving the query with the rowlock request. Next, the database system inserts a rowlock relation into a query execution plan corresponding to the query. Then, a rowlock operator is created for the query execution plan. Next, the plurality of rowlock accessors are set to enable locking of a plurality of targeted rows. Then, during execution of the query execution plan, a given rowlock accessor is accessed via the rowlock operator to lock at least one row.

### TECHNICAL FIELD

The present disclosure generally relates to locking rows of a database table for diverse stores.

### BACKGROUND

Database management systems have become an integral part of many computer systems. For example, some systems handle hundreds if not thousands of transactions per second. On the other hand, some systems perform very complex multidimensional analysis on data. In both cases, the underlying database may need to handle responses to queries very quickly in order to satisfy systems requirements with respect to transaction time. A database query is a mechanism for retrieving data from one or more database tables. Queries may be generated in accordance with a corresponding query language. For example, structured query language (SQL) is a declarative querying language that is used to retrieve data from a relational database. Given the complexity of queries and/or the volume of queries, the underlying databases face challenges when attempting to optimize performance.

### SUMMARY

In some implementations, a database system receives a query targeting a plurality of different database table types, where the query includes a rowlock request. The database system creates a plurality of rowlock accessors for a plurality of storage layers in response to receiving the query with the rowlock request. Next, the database system inserts a rowlock relation into a query execution plan corresponding to the query. Then, a rowlock operator is created for the query execution plan. Next, the plurality of rowlock accessors are set to enable locking of a plurality of targeted rows. Then, during execution of the query execution plan, a given rowlock accessor is accessed via the rowlock operator to lock at least one row.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a database system, in accordance with some example implementations of the current subject matter;

FIG. 2 illustrates a block diagram of a database execution engine, in accordance with some example implementations of the current subject matter;

FIG. 3 illustrates a block diagram of a database environment, in accordance with some example implementations of the current subject matter;

FIG. 4 illustrates a query and a corresponding query plan fragment, in accordance with some example implementations of the current subject matter;

FIG. 5 illustrates a class diagram of a plan generation layer and a plan execution layer, in accordance with some example implementations of the current subject matter;

FIG. 6 illustrates sequence diagrams of a plan generation phase and a plan execution phase, in accordance with some example implementations of the current subject matter;

FIG. 7 illustrates a process for implementing rowlocking for diverse stores, in accordance with some example implementations of the current subject matter;

FIG. 8 illustrates a process for executing queries with rowlock requests targeting multiple database table types, in accordance with some example implementations of the current subject matter;

FIG. 9A depicts an example of a system, in accordance with some example implementations of the current subject matter; and

FIG. 9B depicts another example of a system, in accordance with some example implementations of the current subject matter.

### DETAILED DESCRIPTION

While database isolation levels such as read committed or repeatable read protect users against certain concurrent access patterns, these isolation levels fail to protect against lost updates. For this purpose, SQL introduced SELECT-FOR-UPDATE, which allows users to lock certain rows in a table. The previous mechanism used to implement the row-locking could only target exactly one storage (either column-store or row-store) within the same query. Using the techniques described herein, different stores are able to be combined together in the same query by forming a join or a cross product.

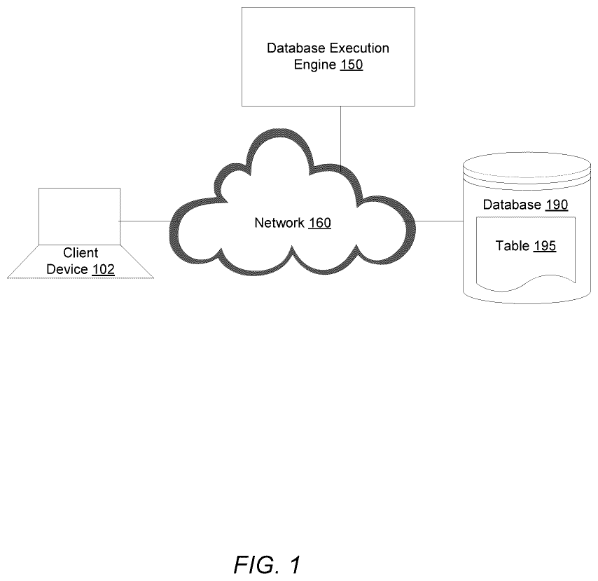

FIG. 1 depicts a system diagram illustrating an example of a database system 100, in accordance with some example embodiments. Referring to FIG. 1, the database system 100 may include one or more client devices 102, a database execution engine 150, and one or more databases 190. As shown in FIG. 1, the one or more client devices 102, the database execution engine 150, and the one or more databases 190 may be communicatively coupled via a network 160. The one or more databases 190 may include a variety of relational databases including, for example, an in-memory database, a column-based database, a row-based database, and/or the like. The database execution engine 150 may store a database table 195 at the one or more databases 190, with the database table 195 representative of any number and type of tables.

In some example embodiments, the one or more databases 190 may include a relational database. However, it should be appreciated that the one or more databases 190 may include any type of database including, for example, an in-memory database, a hierarchical database, an object database, an object-relational database, and/or the like. For example, instead of and/or in addition to including a relational database, the one or more databases 190 may include a graph database, a column store, a key-value store, a document store, and/or the like.

The one or more client devices 102 may include processor-based devices including, for example, a mobile device, a wearable apparatus, a personal computer, a workstation, an Internet-of-Things (IOT) appliance, and/or the like. The network 160 may be a wired network and/or wireless network including, for example, a public land mobile network (PLMN), a local area network (LAN), a virtual local area network (VLAN), a wide area network (WAN), the Internet, and/or the like.

To illustrate by way of an example, a given client device 102 may send a query via the database execution engine 150 to the database layer including the one or more databases 190, which may represent a persistence and/or storage layer where database tables may be stored and/or queried. Furthermore, the database execution engine 150 may provide the ability to access table storage via an abstract interface to a table adapter, which may reduce dependencies on specific types of storage and persistence layers, which may in turn enable use with different types of storage and persistence layers.

The database execution engine 150 may be configured to handle different types of databases and the corresponding persistent layers and/or tables therein. For example, the one or more databases 190 may include at least one row-oriented database, in which case an insert is performed by adding a row with a corresponding row identifier. Alternatively and/or additionally, the one or more databases 190 may include one or more column store databases, which may use dictionaries and compressive techniques when inserting data into a table. Where the database layer includes multiple different types of databases, the database execution engine 150 may perform execution related to handling the differences between different types of databases such as row-oriented databases and column store databases. This may enable a reduction in processing at the database layer, for example, at each of the one or more databases 190. Moreover, the database execution engine 150 may perform other operations including role-based operations, such as joins and projections, as well as filtering, group by, multidimensional analysis, and/or the like to reduce the processing burden on the database layer. In this way, the database execution engine 150 may execute these and other complex operations, while the one or more databases 190 can perform simpler operations to reduce the processing barden at the one or more databases 190.

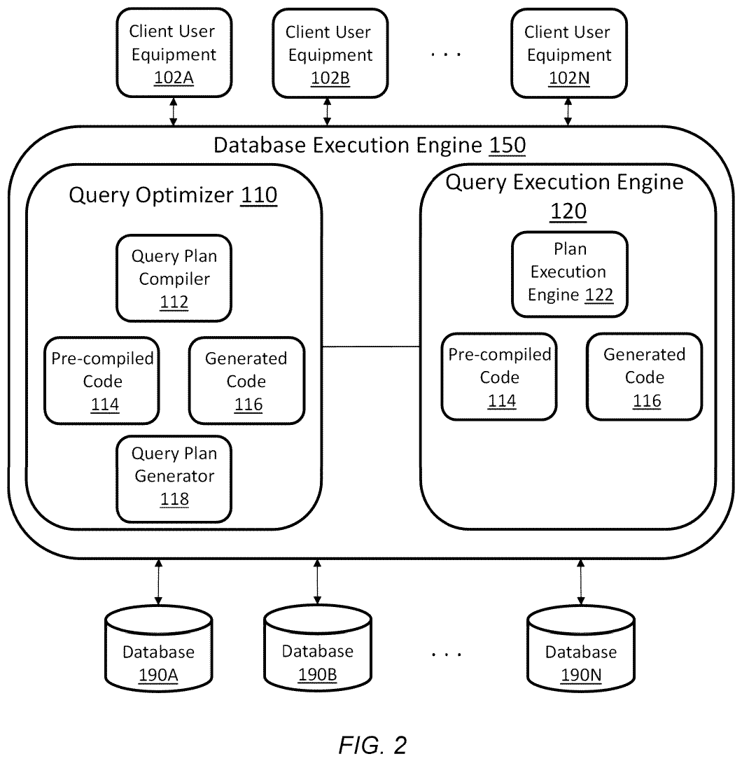

FIG. 2 depicts a block diagram illustrating an example of the database execution engine 150, in accordance with some example embodiments. As shown in FIG. 2, the one or more databases 190 may include a first database 190A, a second database 190B, a third database 190N, and so on. The one or more databases 190 can represent the database layer of a database management system (DBMS) where data may be persisted and/or stored in a structured way, and where the data may be queried or operated on using operations such as SQL commands or other types of commands/instructions to provide reads, writes, and/or perform other operations. To illustrate by way of an example, one or more client devices, which may include the client user equipment 102A-N, may send queries via the database execution engine 150 to the database layer including the one or more databases 190, which may represent a persistence and/or storage layer where database tables may be stored and/or queried. The queries may be sent via a connection, such as a wired connection and/or wireless connection (e.g., the Internet, cellular links, WiFi links, and/or the like) provided, for example, by the network 160.

In an example, the database execution engine 150 may include a query optimizer 110, such as a SQL optimizer and/or another type of optimizer, to receive at least one query from the one or more client devices 102 and generate a corresponding query plan (which may be optimized) for execution by a query execution engine 120. The query optimizer 110 may receive a request, such as a query, and then form or propose an optimized query plan. The query plan (which may be optimized) may be represented as a so-called “query algebra” or “relational algebra.” The query plan may propose an optimum query plan with respect to, for example, the execution time of the overall query. To optimize a query, the query plan optimizer 110 may obtain one or more costs for the different ways the execution of the query plan may be performed, and the costs may be in terms of execution time at, for example, the one or more databases 190.

A query plan compiler 112 may enable compilation of at least a portion of the query plan. The query plan compiler 112 may compile the optimized query algebra into operations, such as program code and/or any other type of command, operation, object, or instruction. This code may include pre-compiled code 114 (which may be pre-compiled and stored and then selected for certain operations in the query plan) and/or generated code 116 generated specifically for execution of the query plan. For example, the query plan compiler 112 may select pre-compiled code 114 for a given operation as part of the optimization of the query plan, while for another operation in the query plan the query plan compiler 112 may allow a compiler to generate the code (i.e., generated code 116). The pre-compiled code 114 and the generated code 116 represent code for executing the query plan, and this code may be provided to a query plan generator 118, which interfaces with the query execution engine 120.

In some example embodiments, the query optimizer 110 may optimize the query plan by compiling and generating code. Moreover, the query optimizer 110 may optimize the query plan to enable pipelining during execution. The query execution engine 120 may receive, from the query plan generator 118, compiled code to enable execution of the optimized query plan, although the query execution engine 120 may also receive code or other commands directly from a higher-level application or another source such as the one or more client devices 102. The pre-compiled code 114 and/or the generated code 116 may be provided to a plan execution engine 122 of the query execution engine 120. The plan execution engine 122 may then prepare the plan for execution, and this query plan may include the pre-compiled code 114 and/or the generated code 116. When the code for the query plan is ready for execution during runtime, the query execution engine 120 may step through the code, performing some of the operations within the database execution engine 150 and sending some of the operations (or commands in support of an operation, such as a read, write, and/or the like) for execution at one or more of one or more database 190.

In some example embodiments, the query execution engine 120 may run, as noted above, the generated code 116 generated for some query operations, while the pre-compiled code 114 may be run for other operations. Moreover, the query execution engine 120 may combine the generated code 116 with the pre-compiled code 114 to further optimize execution of query related operations. In addition, the query execution engine 120 may provide for a plan execution framework that is able to handle data chunk(s), pipelining, and state management during query execution. Furthermore, the query execution engine 120 may provide the ability to access table storage via an abstract interface to a table adapter, which may reduce dependencies on specific types of storage/persistence layers (which may enable use with different types of storage/persistence layers).

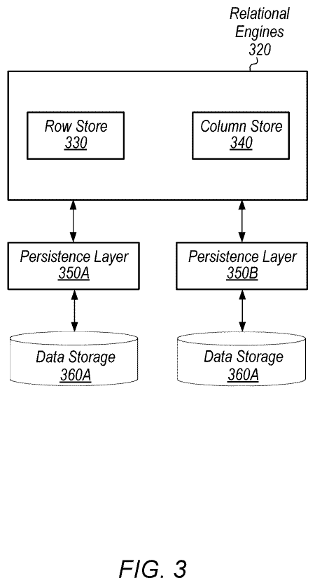

Referring now to FIG. 3, a block diagram of a database environment 300 is depicted, in accordance with one or more embodiments of the current subject matter. In an example, database environment 300 includes relational engines 320, including an in-memory row store 330 and column store 340. The row store 330 stores data in a row based way, and the column store is a column based in-memory data engine, particularly suited to text analysis and search capabilities. As row based tables and columnar tables can be combined in one SQL statement, the corresponding engines must be able to consume intermediate results created by the other. Each of the row store 330 and column store 340 process data differently. For example, row store operators process data in a row-at-a-time fashion using iteration. Column store operations (such as scan, aggregate and so on) require that the entire column be available in contiguous memory locations. To exchange intermediate results, the row store 330 can provide results to the column store 340 materialized as complete rows in memory, while the column store 340 can expose results using the iteration needed by the row store 330.

The database environment 300 also includes persistence layers 350A-B, which are responsible for durability and atomicity of transactions. The persistence layers 350A-B ensure that the database is restored to the most recent committed state after a restart and that transactions are either completely executed or completely undone. To achieve this goal in an efficient way, the persistence layers 350A-B may use a combination of write-ahead logs, shadow paging and savepoints. The persistence layers 350A-B may also provide interfaces for writing and reading data from a corresponding data storage 360A-B. The persistence layers 350A-B may also provide mechanisms for locking rows to prevent concurrent access to the same row by different threads.

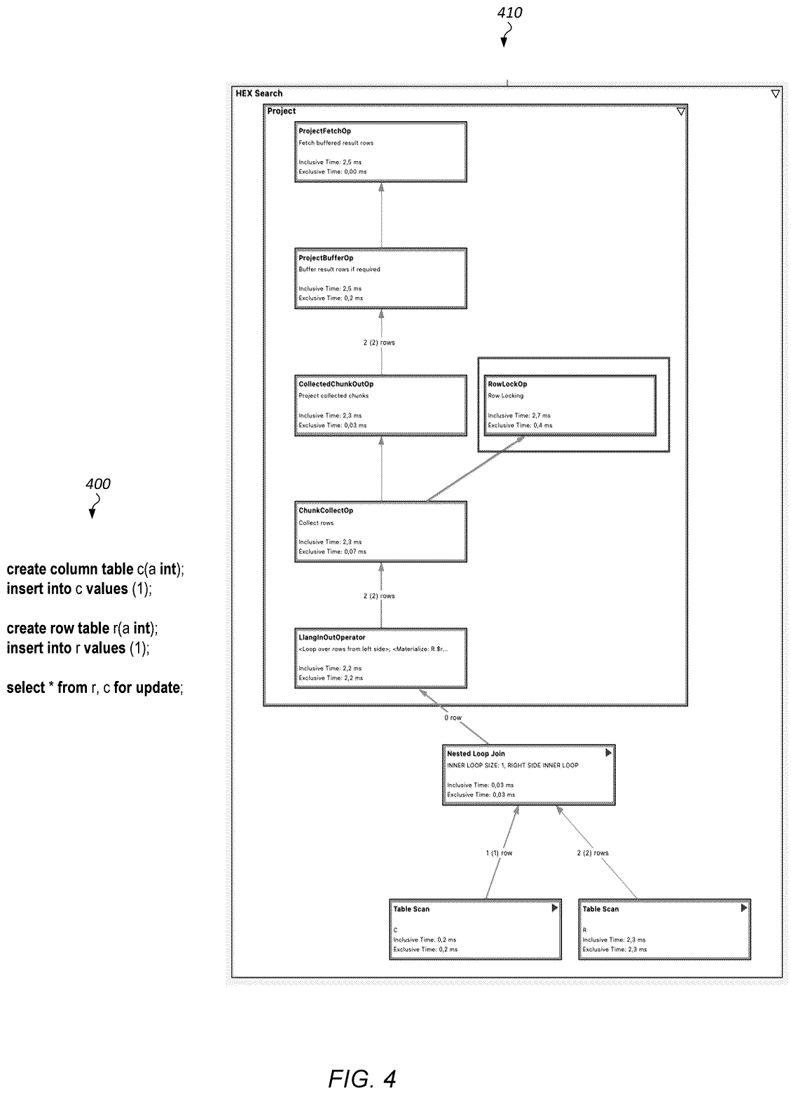

Turning now to FIG. 4, an example of a query 400 and a corresponding query plan fragment 410 are depicted, in accordance with one or more embodiments of the current subject matter. While database isolation levels such as read committed or repeatable read protect users against certain concurrent access patterns, these isolation levels fail to protect against lost updates. For this purpose, SQL introduced SELECT-FOR-UPDATE, which allows users to lock certain rows in a table. The previous mechanism used to implement the row-locking could only target exactly one storage (either column-store or row-store) within the same query. Using the techniques described herein, different stores are able to be combined together in the same query by forming a join or a cross product, such as in the query 400 shown on the left-side of FIG. 4.

The query 400 leads to the following plan 410 shown on the right-side of FIG. 4. At the bottom of plan 410 are the column store and the row store as well as a join which combines the two stores. In this case, the join is a cross product. Plan 410 implements the runtime semantics of the query with additional locking of rows based on a unique identifier called a row identifier (or RID). The row locking operator (or “RowLockOp”) is shown on the right-side of plan 410. In some embodiments, the methods and mechanisms for implementing this plan and other similar plans may be based on dependency injection.

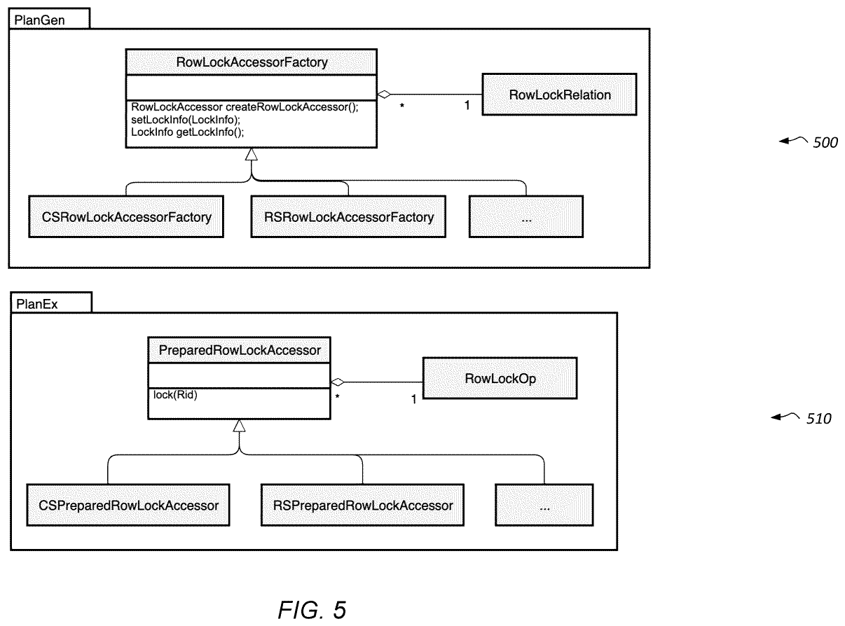

Referring now to FIG. 5, a class diagram of a plan generation layer 500 and a plan execution layer 510 is depicted, in accordance with one or more embodiments of the current subject matter. An execution engine (e.g., query execution engine 120 of FIG. 2) may include multiple layers such as a plan generation layer and a plan execution layer. As shown in FIG. 5, plan generation layer 500 builds an execution plan and plan execution layer 510 executes the plan. Plan generation layer 500 includes factories which are different based on the different tables that are supported. For example, plan generation layer 500 includes a column store rowlock accessor factory and a row store rowlock accessor factory. The column store rowlock accessor factory and the row store rowlock accessor factory contain coordinates with which the execution engine is able to access the different underlying storage mechanisms which allow for locking a particular row. The mechanisms are the rowlock accessors which communicate directly to the persistence layer, and have the ability to lock a certain row based on a row identifier (RID). The RID identifies within the persistence layer which row should be locked.

In an example, plan generation layer 500 is created during plan generation and is transient, going away when the actual plan has been built. Plan execution layer 510 survives plan creation and is used during plan execution by the rowlock operator which is traversed and locked based on the RID. With this mechanism, a mixed plan having a combination of two persistence layers enables row locking using an operator which is governed by the internal factories which create the accessors which handle the persistence layer mechanics.

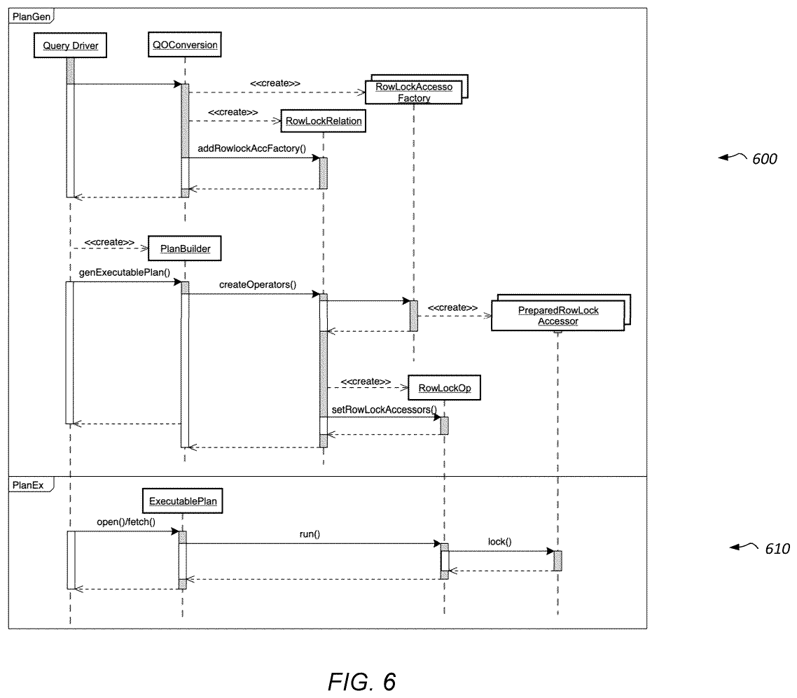

Turning now to FIG. 6, sequence diagrams 600 and 610 of a plan generation phase and a plan execution phase are shown, in accordance with one or more embodiments of the current subject matter. In the plan generation phase, the query driver implements the conversion process whereby the rowlock accessor factory, which contains the coordinates of the storage layers that will be accessed later, is created and the rowlock relation, which is the relational operator from the relational algebra, is inserted into the plan. Later, in the plan building process of the plan generation phase, the operators are created to prepare the rowlock accessor. Then, the rowlock operator is created and the rowlock accessors, which can actually lock the rows, are set for the rowlock operator.

At the bottom of FIG. 6, the sequence diagram 610 of the plan execution phase is depicted. During the plan execution phase, the rowlock accessors are accessed via the rowlock operators which were created during the plan generation phase. This results in the individual rows, identifier by their row IDs, being locked via the corresponding persistence layers.

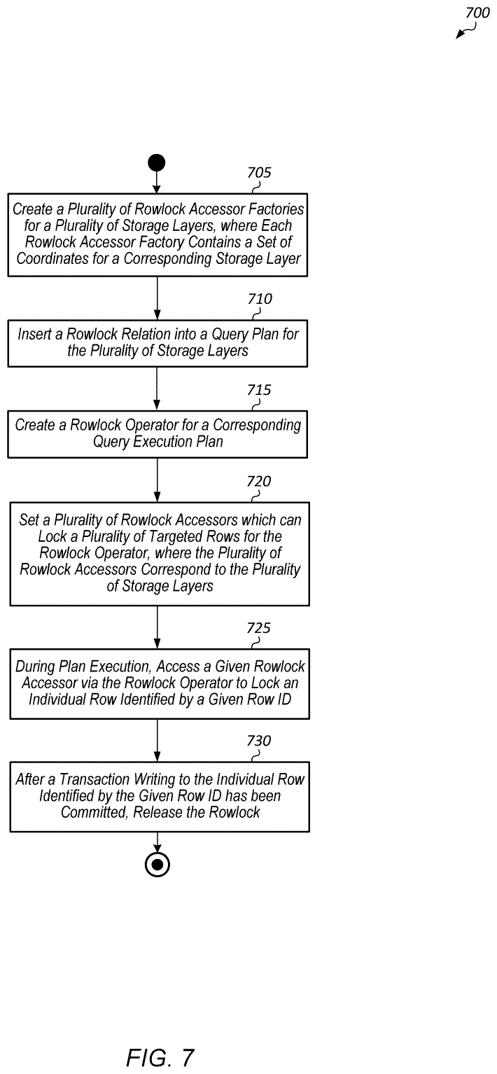

Referring now to FIG. 7, a process for implementing rowlocking for diverse stores is depicted, in accordance with one or more embodiments of the current subject matter. At the beginning of method 700, a plurality of rowlock accessor factories are created for a plurality of storage layers, where each rowlock accessor factory contains a set of coordinates for a corresponding storage layer (block 705). For example, in block 705, a first rowlock accessor factory containing a first set of coordinates of a first storage layer may be created, a second rowlock accessor factory containing a second set of coordinates of a second storage layer may be created, and so on. Next, a rowlock relation is inserted into a query plan for the plurality of storage layers (block 710). Then, a rowlock operator is created for a corresponding query execution plan (block 715). Next, a plurality of rowlock accessors which can lock a plurality of targeted rows are set for the rowlock operator, where the plurality of rowlock accessors correspond to the plurality of storage layers (block 720). Then, during plan execution, a given rowlock accessor is accessed via the rowlock operator to lock an individual row identified by a given row identifier (ID) (block 725). After a transaction writing to the individual row identified by the given row ID has been committed, the rowlock is released (block 730). After block 730, method 700 may end.

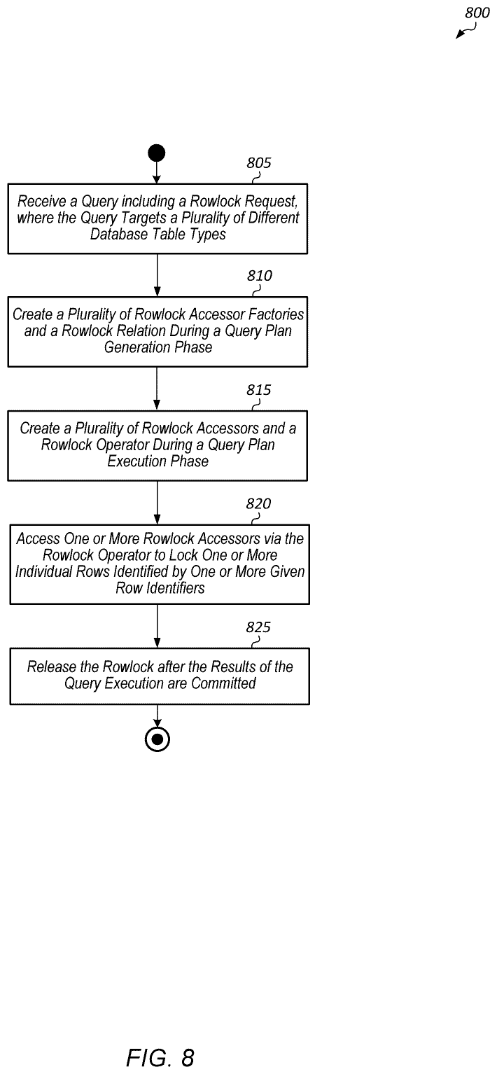

Referring now to FIG. 8, a process for executing queries with rowlock requests targeting multiple database table types is depicted, in accordance with one or more embodiments of the current subject matter. A query including a rowlock request is received by a database execution engine (e.g., database execution engine 150 of FIG. 1), where the query targets a plurality of different database table types (block 805). In an example, the query may include a SELECT FOR UPDATE command to lock the rows returned by the SELECT query. In an example, the plurality of different database table types include at least a column store table and a row store table. In response to receiving the query which includes the rowlock request and which targets a plurality of different database table types, the database execution engine creates a plurality of rowlock accessor factories and a rowlock relation during a query plan generation phase (block 810). Also, the database execution engine creates a plurality of rowlock accessors and a rowlock operator during a query plan execution phase (block 815). Next, during query execution, the database execution engine accesses one or more rowlock accessors via the rowlock operator to lock one or more individual rows identified by one or more given row identifiers (IDs) (block 820).

After the results of the query execution are committed, the database execution engine releases the rowlock (block 825). After block 825, method 800 ends.

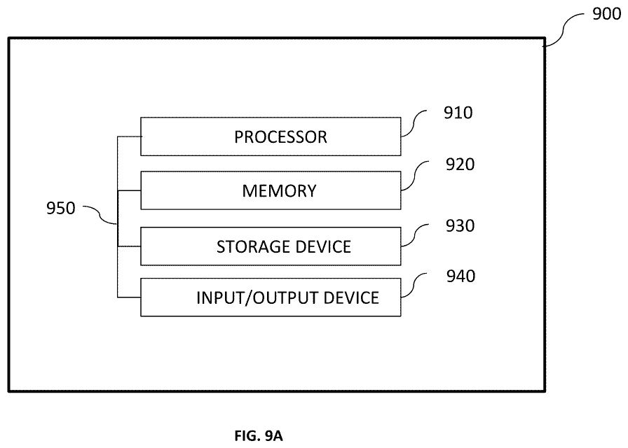

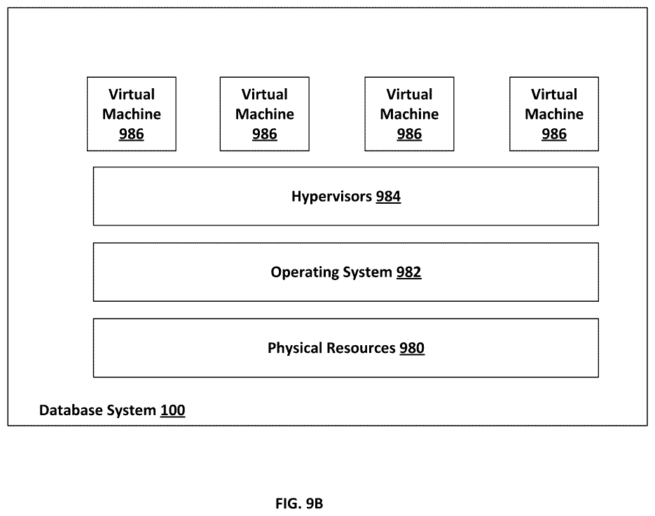

In some implementations, the current subject matter may be configured to be implemented in a system 900, as shown in FIG. 9A. The system 900 may include a processor 910, a memory 920, a storage device 930, and an input/output device 940. Each of the components 910, 920, 930 and 940 may be interconnected using a system bus 950. The processor 910 may be configured to process instructions for execution within the system 900. In some implementations, the processor 910 may be a single-threaded processor. In alternate implementations, the processor 910 may be a multi-threaded processor. The processor 910 may be further configured to process instructions stored in the memory 920 or on the storage device 930, including receiving or sending information through the input/output device 940. The memory 920 may store information within the system 900. In some implementations, the memory 920 may be a computer-readable medium. In alternate implementations, the memory 920 may be a volatile memory unit. In yet some implementations, the memory 920 may be a non-volatile memory unit. The storage device 930 may be capable of providing mass storage for the system 900. In some implementations, the storage device 930 may be a computer-readable medium. In alternate implementations, the storage device 930 may be a floppy disk device, a hard disk device, an optical disk device, a tape device, non-volatile solid state memory, or any other type of storage device. The input/output device 940 may be configured to provide input/output operations for the system 900. In some implementations, the input/output device 940 may include a keyboard and/or pointing device. In alternate implementations, the input/output device 940 may include a display unit for displaying graphical user interfaces.

FIG. 9B depicts an example implementation of the database system 100 (of FIG. 1). The database system 100 may be implemented using various physical resources 980, such as at least one or more hardware servers, at least one storage, at least one memory, at least one network interface, and the like. The database system 100 may also be implemented using infrastructure, as noted above, which may include at least one operating system 982 for the physical resources 980 and at least one hypervisor 984 (which may create and run at least one virtual machine 986). For example, each multitenant application may be run on a corresponding virtual machine 986.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: receiving a query targeting a plurality of different database table types, wherein the query includes a rowlock request; creating a plurality of rowlock accessors for a plurality of storage layers responsive to receiving the query with the rowlock request; inserting a rowlock relation into a query execution plan corresponding to the query; creating a rowlock operator for the query execution plan; setting the plurality of rowlock accessors to enable locking of a plurality of targeted rows; and during execution of the query execution plan, accessing a given rowlock accessor via the rowlock operator to lock at least one row.

Example 2: The computer-implemented method of Example 1, wherein the plurality of storage layers correspond to the plurality of different database table types.

Example 3: The computer-implemented method of any of Examples 1-2, wherein the plurality of different database table types comprise a column-store table and a row-store table.

Example 4: The computer-implemented method of any of Examples 1-3, wherein the at least one row is identified by at least one row identifier.

Example 5: The computer-implemented method of any of Examples 1-4, wherein each rowlock accessor contains a set of coordinates for a corresponding storage layer.

Example 6: The computer-implemented method of any of Examples 1-5, wherein the plurality of rowlock accessors are created during a plan generation phase of the query execution plan.

Example 7: The computer-implemented method of any of Examples 1-6, wherein the at least one row is locked via a corresponding persistence layer.

Example 8: A system comprising: at least one processor; and at least one memory storing instructions that, when executed by the at least one processor, cause operations comprising: receiving a query targeting a plurality of different database table types, wherein the query includes a rowlock request; creating a plurality of rowlock accessors for a plurality of storage layers responsive to receiving the query with the rowlock request; inserting a rowlock relation into a query execution plan corresponding to the query; creating a rowlock operator for the query execution plan; setting the plurality of rowlock accessors to enable locking of a plurality of targeted rows; and during execution of the query execution plan, accessing a given rowlock accessor via the rowlock operator to lock at least one row.

Example 9: The system of Example 8, wherein the plurality of storage layers correspond to the plurality of different database table types.

Example 10: The system of any of Examples 8-9, wherein the plurality of different database table types comprise a column-store table and a row-store table.

Example 11: The system of any of Examples 8-10, wherein the at least one row is identified by at least one row identifier.

Example 12: The system of any of Examples 8-11, wherein each rowlock accessor contains a set of coordinates for a corresponding storage layer.

Example 13: The system of any of Examples 8-12, wherein the plurality of rowlock accessors are created during a plan generation phase of the query execution plan.

Example 14: The system of any of Examples 8-13, wherein the at least one row is locked via a corresponding persistence layer.

Example 15: A non-transitory computer readable medium storing instructions, which when executed by at least one data processor, result in operations comprising: receiving a query targeting a plurality of different database table types, wherein the query includes a rowlock request; creating a plurality of rowlock accessors for a plurality of storage layers responsive to receiving the query with the rowlock request; inserting a rowlock relation into a query execution plan corresponding to the query; creating a rowlock operator for the query execution plan; setting the plurality of rowlock accessors to enable locking of a plurality of targeted rows; and during execution of the query execution plan, accessing a given rowlock accessor via the rowlock operator to lock at least one row.

Example 16: The non-transitory computer readable medium of Example 15, wherein the plurality of storage layers correspond to the plurality of different database table types.

Example 17: The non-transitory computer readable medium of any of Examples 15-16, wherein the plurality of different database table types comprise a column-store table and a row-store table.

Example 18: The non-transitory computer readable medium of any of Examples 15-17, wherein the at least one row is identified by at least one row identifier.

Example 19: The non-transitory computer readable medium of any of Examples 15-18, wherein each rowlock accessor contains a set of coordinates for a corresponding storage layer.

Example 20: The non-transitory computer readable medium of any of Examples 15-19, wherein the plurality of rowlock accessors are created during a plan generation phase of the query execution plan.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order. to achieve desirable results. Other implementations can be within the scope of the following claims.

1. A computer-implemented method comprising:
receiving, via a query optimizer of a database execution engine and from a user equipment, a structured query language (SQL) query targeting a column-store table and a row-store table, wherein the SQL query includes a rowlock request to lock at least one row in the column-store table and the row-store table;
generating, using the query optimizer, a query execution plan for execution of the SQL query, wherein generating the query execution plan comprises:
creating a plurality of rowlock accessors for a plurality of storage layers responsive to receiving the query with the rowlock request,
inserting a rowlock relation into the query execution plan,
creating a rowlock operator for the query execution plan, and
setting the plurality of rowlock accessors to enable locking of a plurality of targeted rows; and
executing, using a query execution engine of the database execution engine and based on executable code received from a query plan compiler, the query execution plan to execute the SQL query by accessing a given rowlock accessor via the rowlock operator to lock the at least one row,
wherein each of the plurality of rowlock accessors, the rowlock operator, and the rowlock relation is an operator executed at runtime of the SQL query.

2. The computer-implemented method of claim 1, wherein the plurality of storage layers include a first persistence layer that corresponds to the column-store table and a second persistence layer that corresponds to the row-store table.

3. The computer-implemented method of claim 2, wherein the first and second persistence layers are configured to provide persistent storage of data for the column-store and row-store tables, respectively.

4. The computer-implemented method of claim 1, wherein the at least one row is identified by at least one row identifier.

5. The computer-implemented method of claim 1, wherein each rowlock accessor uses a set of coordinates stored in a corresponding rowlock accessor factory for accessing a corresponding storage layer.

6. The computer-implemented method of claim 1, wherein the plurality of rowlock accessors are created during a plan generation phase of the query execution plan.

7. The computer-implemented method of claim 1, wherein the at least one row is locked via a corresponding persistence layer.

8. A system comprising:
at least one processor; and
at least one memory storing instructions that, when executed by the at least one processor, cause operations comprising:
receiving, via a query optimizer of a database execution engine and from a user equipment, a structured query language (SQL) query targeting a column-store table and a row-store table, wherein the SQL query includes a rowlock request to lock at least one row in the column-store table and the row-store table;
generating, using the query optimizer, a query execution plan for execution of the SQL query, wherein generating the query execution plan comprises:
creating a plurality of rowlock accessors for a plurality of storage layers responsive to receiving the query with the rowlock request,
inserting a rowlock relation into the query execution plan,
creating a rowlock operator for the query execution plan, and
setting the plurality of rowlock accessors to enable locking of a plurality of targeted rows; and
executing, using a query execution engine of the database execution engine and based on executable code received from a query plan compiler, the query execution plan to execute the SQL query accessing a given rowlock accessor via the rowlock operator to lock the at least one row,
wherein each of the plurality of rowlock accessors, the rowlock operator, and the rowlock relation is an operator executed at runtime of the SQL query.

9. The system of claim 8, wherein the plurality of storage layers include a first persistence layer that corresponds to the column-store table and a second persistence layer that corresponds to the row-store table.

10. The system of claim 9, wherein the first and second persistence layers are configured to provide persistent storage of data for the column-store and row-store tables, respectively.

11. The system of claim 8, wherein the at least one row is identified by at least one row identifier.

12. The system of claim 8, wherein each rowlock accessor uses a set of coordinates stored in a corresponding rowlock accessor factory for accessing a corresponding storage layer.

13. The system of claim 8, wherein the plurality of rowlock accessors are created during a plan generation phase of the query execution plan.

14. The system of claim 8, wherein the at least one row is locked via a corresponding persistence layer.

15. A non-transitory computer readable medium storing instructions, which when executed by at least one data processor, result in operations comprising:
receiving, via a query optimizer of a database execution engine and from a user equipment, a structured query language (SQL) query targeting a column-store table and a row-store table, wherein the query includes a rowlock request to lock at least one row in the column-store table and the row-store table;
generating, using the query optimizer, a query execution plan for execution of the SQL query, wherein generating the query execution plan comprises:
creating a plurality of rowlock accessors for a plurality of storage layers responsive to receiving the query with the rowlock request,
inserting a rowlock relation into the query execution plan,
creating a rowlock operator for the query execution plan, and
setting the plurality of rowlock accessors to enable locking of a plurality of targeted rows; and
executing, using a query execution engine of the database execution engine and based on executable code received from a query plan compiler, the query execution plan to execute the SQL query by accessing a given rowlock accessor via the rowlock operator to lock the at least one row,
wherein each of the plurality of rowlock accessors, the rowlock operator, and the rowlock relation is an operator executed at runtime of the SQL query.

16. The non-transitory computer readable medium of claim 15, wherein the plurality of storage layers include a first persistence layer that corresponds to the column-store table and a second persistence layer that corresponds to the row-store table.

17. The non-transitory computer readable medium of claim 16, wherein the first and second persistence layers are configured to provide persistent storage of data for the column-store and row-store tables, respectively.

18. The non-transitory computer readable medium of claim 15, wherein the at least one row is identified by at least one row identifier.

19. The non-transitory computer readable medium of claim 15, wherein each rowlock accessor uses a set of coordinates stored in a corresponding rowlock accessor factory for accessing a corresponding storage layer.

20. The non-transitory computer readable medium of claim 15, wherein the plurality of rowlock accessors are created during a plan generation phase of the query execution plan.
